(19) United States
(12) Patent Application Publication
(10) Pub. No.: US 2023/0043553 A1
(43) Pub. Date: Feb. 9, 2023

(54) FITNESS EQUIPMENT LED ELECTRONIC METER

(71) Applicant: XIAMEN ZLINK ELECTRONIC TECHNOLOGY CO., LTD, Xiamen, Fujian (CN)

(72) Inventor: Kefeng Zhao, Xiamen (CN)

(21) Appl. No.: 17/789,509

(22) PCT Filed: Apr. 2, 2020
(86) PCT No.: PCT/CN2020/082987

§ 371 Date: Jun. 27, 2022

(51) Int. Cl. G09F 9/33; A63B 71/06

(52) U.S. Cl. CPC G09F 9/33; A63B 71/0622

(57) ABSTRACT

A fitness equipment LED electronic meter, comprising a PCB, a support, and a panel, wherein the PCB is connected to the back surface of the support, and the panel is locked to the front surface of the support; the front surface of the PCB is provided with a display module consisting of a plurality of LEDs; a plurality of first grooves passing through the support are provided on the support; the LEDs are fitted in the first grooves; a diffusion film and a semitransparent plate are sandwiched between the panel and the support, and sequentially abut against the front surface of the support. The fitness equipment LED electronic meter improves the display effect of the electronic meter, avoids the situation that the display effect of the electronic meter is affected due to deformation of the panel and loosening of screws, and improves the fitness experience of people.

### BACKGROUND OF THE INVENTION

### 1. Field of the Invention

The present invention relates to fitness equipment, and more particularly to a fitness equipment LED electronic meter.

### 2. Description of the Prior Art

In general, the electronic meter of fitness equipment adopts a LCD (liquid-crystal display) display, and its structure is shown in FIG. 1. A conventional electronic meter includes a PCB (printed circuit board) 1′, a panel 3′ and a LCD screen 2′. The panel 3′ and the PCB 1′ are locked by screws. The LCD screen 2′ in cooperation with an EVA (ethyl vinyl acetate) strip 5′ is sandwiched between the panel 3′ and the PCB 1′. The LCD screen 2′ is electrically connected to the PCB 1′ through an electrically conductive strip 4′. When the panel 3′ is deformed or the screws are loose, the positions of the LCD screen 2′ and the electrically conductive strip 4′ will be shifted, which may cause a poor contact between the LCD screen 2′ and the PCB 1′. As a result, the electronic meter may malfunction or does not have images, which affects the user experience.

Accordingly, the inventor of the present invention has devoted himself based on his many years of practical experiences to solve these problems.

### SUMMARY OF THE INVENTION

In view of the drawbacks of the prior art, the primary object of the present invention is to provide a fitness equipment LED electronic meter, which can improve the display effect of the electronic meter.

In order to achieve the above object, the present invention adopts the following technical solutions.

A fitness equipment LED (light-emitting diode) electronic meter comprises a PCB (printed circuit board), a support, and a panel. The PCB is connected to a back surface of the support. The panel is locked to a front surface of the support.

A display module consisting of a plurality of LEDs (light-emitting diodes) is disposed on a front surface of the PCB. A plurality of first grooves passing through the support are disposed on the support. The LEDs are fitted in the first grooves.

A diffusion film and a semitransparent plate are sandwiched between the panel and the support. The diffusion film and the semitransparent plate sequentially abut against the front surface of the support.

The plurality of first grooves of the support are independent of each other.

The PCB is in snap-fit with the back surface of the support.

The support and the panel have corresponding locking holes.

The locking hole of the support is in the form of an elongated hole.

A second groove is disposed on the front surface of the support. The diffusion film and the semitransparent plate are fitted in the second groove.

A depth of the second groove is greater than a thickness of the diffusing film, but less than or equal to the sum of the thickness of the diffusing film and a thickness the semitransparent plate.

The PCB further includes a main control chip. The display module has at least one bit code control terminal and four segment code control terminals. The bit code control terminal and the segment code control terminals are connected to IO ports of the main control chip, respectively.

The display module includes at least one display unit. The display unit is connected to the bit code control terminal. The display unit includes four LED units. Each LED unit consists of two LEDs that are connected in reverse parallel to each other. One end of each of the four LED units is connected to the bit code control terminal connected to the display unit, and another ends of the four LED units are connected to the four segment code control terminals, respectively.

The PCB further includes a power supply module and a booster circuit module. The power supply module is connected to the main control chip via the booster circuit module.

The circuit further includes a voltage acquisition module, a sensor signal acquisition module, a heart rate signal acquisition module, and a button circuit module. The voltage acquisition module is connected to the power supply unit and the main control chip. The sensor signal acquisition module, the heart rate signal acquisition module and the button circuit module are all connected to the main control chip.

With the above solutions, in the present invention, the LEDs used for display and the PCB used to control the display of the LEDs are directly welded together to form a whole. Thus, the stability of the connection of the display part of the electronic meter is realized, the problem of poor contact caused by external reasons is avoided effectively, and the display effect of the electronic meter is improved. After that, the PCB is connected to the support, and then the support and the panel are locked together, which realizes the relative separation of the display part of the electronic meter and the panel, avoids the situation that the display effect of the electronic meter is affected due to deformation of the panel, and improves the user experience. The diffusion film and the semitransparent plate are sandwiched between the support and the panel, which can improve the display effect of the electronic meter and further improve the user experience.

In addition, in present invention, the display module of the electronic meter is composed of at least one display unit. Each display unit of includes four LED units. The four LED units are connected to the four segment code control terminals, respectively. Each LED unit consists of two LEDs that are connected in reverse parallel to each other, so that the two LEDs share a segment code control terminal. Therefore, the number of the IO ports of the main control chip occupied by the display unit is reduced, thereby reducing the cost of the display module.

### BRIEF DESCRIPTION OF THE DRAWINGS

FIG. 1 is an exploded view of a conventional electronic meter;

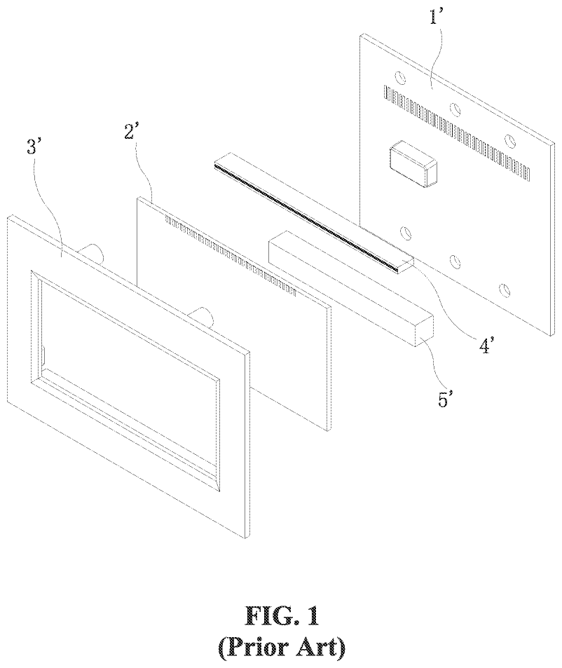

FIG. 2 is an exploded view of the electronic meter of the present invention;

FIG. 3 is a partial enlarged view of FIG. 2;

FIG. 4 is a rear view of the support of the present invention;

FIG. 5 is a block diagram of the present invention; and

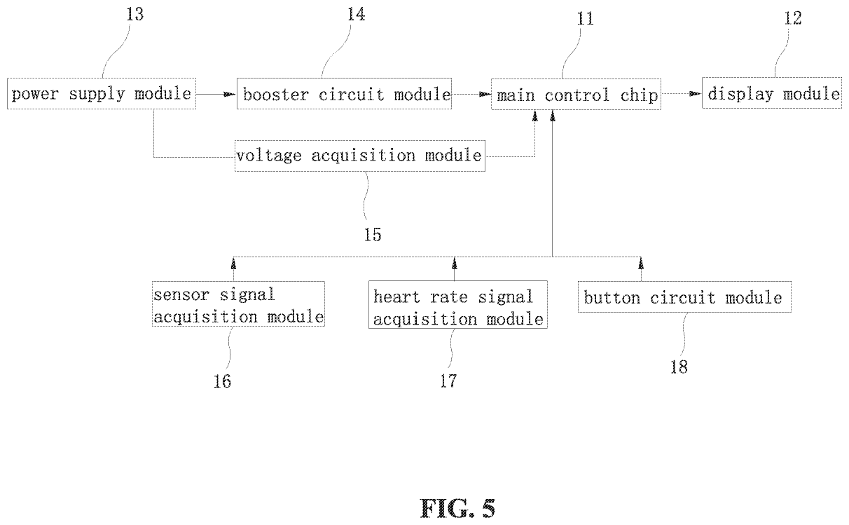

FIG. 6 is a schematic view showing the circuit of the present invention.

### DETAILED DESCRIPTION OF THE PREFERRED EMBODIMENTS

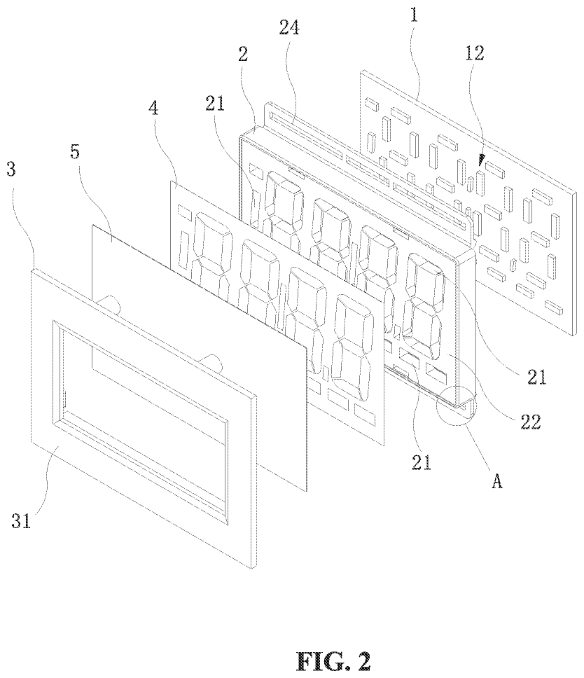

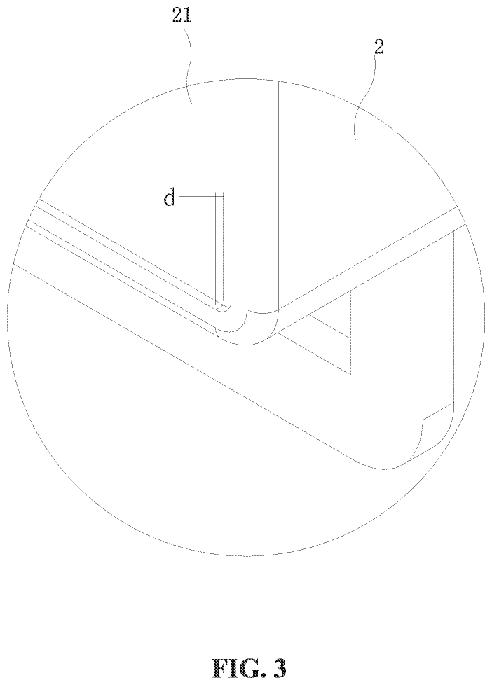

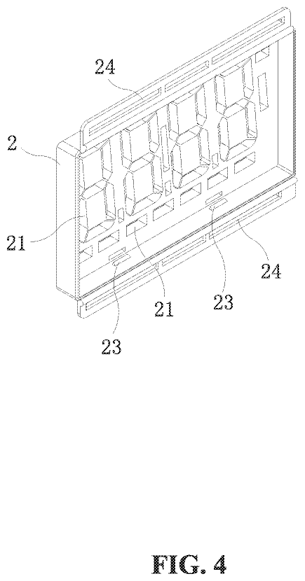

As shown in FIG. 2 through FIG. 4, the present invention discloses a fitness equipment LED electronic meter, comprising a PCB (printed circuit board) 1, a support 2, and a panel 3. The PCB 1 is connected to the back surface of the support 2. The panel 3 is locked to the front surface of the support 2. A display module 12 consisting of a plurality of LEDs (light-emitting diodes) is disposed on the front surface of the PCB 1. A plurality of first moves 21 passing through the support 2 is disposed on the support 2. The LEDs are fitted in the first moves 21. A diffusion film 4 and a semitransparent plate 5 are sandwiched between the panel 3 and the support 2. The diffusion film 4 and the semitransparent plate 5 sequentially abut against the front surface of the support 2.

In the present invention, the LEDs used for display and the PCB 1 used to control the display of the LEDs are directly welded together to form a whole. Thus, the stability of the connection of the display part of the electronic meter is realized, the problem of poor contact caused by external reasons is avoided effectively, and the display effect of the electronic meter is improved. After that, the PCB 1 is connected to the support 2, and then the support 2 and the panel 3 are locked together, thereby realizing the relative separation of the display part of the electronic meter and the panel 3, avoiding the situation that the display effect of the electronic meter is affected due to deformation of the panel 3, and improving the user experience. The diffusion film 4 and the semitransparent plate 5 are sandwiched between the support 2 and the panel 3, which can improve the display effect of the electronic meter and further improve the user experience.

In order to further improve the display effect of the electronic meter, the plurality of first grooves 21 of the support 2 are independent of each other, not in communication with each other. In this way, when one of the LEDs emits light, the light generated by the LED will only illuminate within the range of the corresponding first groove 21, and will not radiate to other areas to affect the user's observation result of the electronic meter.

An engaging block 23 is disposed on the back surface of the support 2. The PCB 1 is in snap-fit with the back surface of the support 2 through the engaging block 23. The support 2 and the panel 3 have corresponding locking holes 24, 31. The support 2 and the panel 3 are locked together by screws passing through the locking holes 24, 31. Preferably, the locking hole 24 of the support 2 may be in the form of an elongated hole. In this way, the relative position of the PCB 1 and the panel 3 can be adjusted by adjusting the position of the screw to be fixed on the locking hole 24 of the support 2, so that the display areas of the PCB 1 and the panel 3 can be matched better.

For the diffusion film 4 and the semitransparent plate 5 to be fitted on the support 2 better, a second groove 23 is disposed on the front surface of the support 2. The diffusion film 4 and the semitransparent plate 5 are fitted in the second groove 23. The second groove 23 is configured to restrict movement of the diffusion film 4 and the semitransparent plate 5. Furthermore, the depth d of the second groove 23 is greater than the thickness of the diffusing film 4, but less than or equal to the sum of the thickness of the diffusing film 4 and the thickness of the semitransparent plate 5. When the panel 3 is locked to the support 2, the panel 3 exerts a force on the semitransparent plate 5, so that the semitransparent plate 5 and the diffusing film 4 are pressed against the front surface of the support 2 well.

The PCB 1 further includes a main control chip 11 connected to the display module 12. Specifically, the display module 12 has at least one bit code control terminal and four segment code control terminals. The bit code control terminal and the segment code control terminals are connected to the IO ports of the main control chip 11, respectively. The display module 12 includes at least one display unit. The display unit is connected to the bit code control terminal. The display unit includes four LED units. Each LED unit consists of two LEDs that are connected in reverse parallel to each other. One end of each of the four LED units is connected to the bit code control terminal connected to the display unit. The other ends of the four LED units are connected to the four segment code control terminals, respectively.

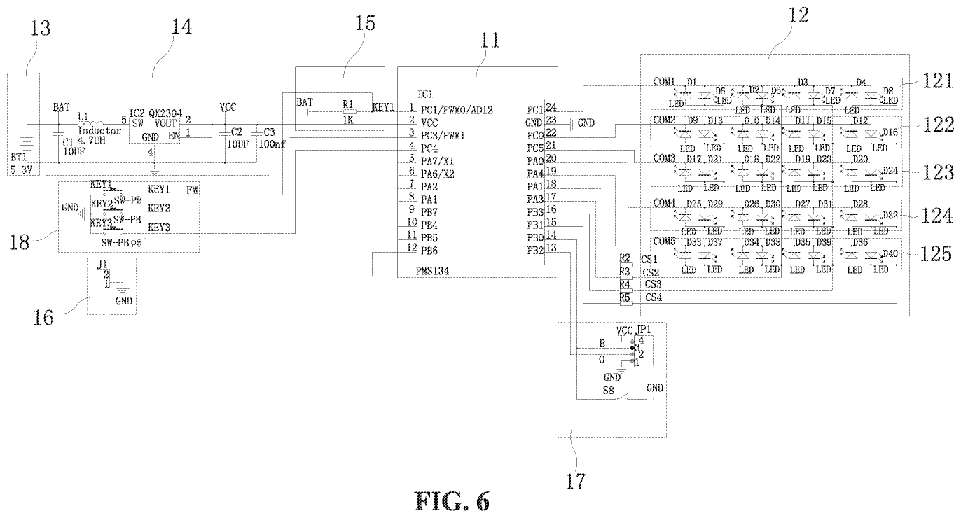

As shown in FIG. 6, the PCB further includes a power supply module 13, a booster circuit module 14, a voltage acquisition module 15, a sensor signal acquisition module 16, a heart rate signal acquisition module 17, and a button circuit module 18. The power module 13 uses two 1.5V batteries. The booster circuit module 14 is implemented by a booster chip IC2. The model of the booster chip IC2 is QX2304. The voltage acquisition module 15 acquires the power of the power supply module 13 and is connected to the main control chip 11. When the voltage of the batteries is lower than the threshold, the main control chip 11 will control the power indicator LED to flash for prompting the user to replace the battery.

The sensor signal acquisition module is used to detect the opening and closing signals of the reed switch or other high and low level signals. The sensor signal acquisition module is connected to the main control chip. The main control chip receives the sensor signal and displays the corresponding value on the LEDs through program calculation. The heart rate signal acquisition module (including but not limited to a hand-held heart rate module and a wireless heart rate module) is connected to two IO ports of the main control chip 11, namely, one enabling port and one signal port. An enable signal is sent to the heart rate signal acquisition module when the host is working or wakes up from sleep. After receiving the heart rate signal, the heart rate signal acquisition module sends the heart rate signal to the main control chip through the signal port. The button circuit module 18 includes three buttons connected to the main control chip 11 for interaction. The three buttons are defined as a mode selection button, a setting button and a reset button, respectively. The setting button is configured to set time, distance, calories, speed, times, times/min, but not limited thereto.

In this embodiment, the display module 12 has five display units, which means that the display module 12 has five bit code control terminals and four segment code control terminals. The five bit code control terminals are defined as a first bit code control terminal COM1, a second bit code control terminal COM2, a third bit code control terminal COM3, a fourth bit code control terminal COM4, and a fifth bit code control terminal COM5. The five bit code control terminals are connected to five IO ports of the main control chip 11, respectively. The four segment code control terminals are defined as a first segment code control terminal S1, a second segment code control terminal S2, a third segment code control terminal S3, and a fourth segment code control terminal S4. The four segment code control terminals are connected to four IO ports of the main control chip 11 through resistors R2, R3, R4, R5, respectively.

The five display units are defined as a first display unit 21, a second display unit 22, a third display unit 23, a fourth display unit 24 and a fifth display unit 25, respectively. The first display unit 21 is composed of LEDs D1-D8. After the LED D1 and the LED D5 are connected in reverse parallel to each other, their two ends are connected to the first bit code control terminal COM1 and the first segment code control terminal S1, respectively. After the LED D2 and the LED D6 are connected in reverse parallel to each other, their two ends are connected to the first bit code control terminal COM1 and the second segment code control terminal S2, respectively. After the LED D3 and the LED D7 are connected in reverse parallel to each other, their two ends are connected to the first bit code control terminal COM1 and the third segment code control terminal S3, respectively. After the LED D4 and the LED D8 are connected in reverse parallel to each other, their two ends are connected to the first bit code control terminal COM1 and the fourth segment code control terminal S4, respectively.

The second display unit 22 is composed of LEDs D9-D16. After the LED D9 and the LED D13 are connected in reverse parallel to each other, their two ends are connected to the second bit code control terminal COM2 and the first segment code control terminal S1, respectively. After the LED D10 and the LED D14 are connected in reverse parallel to each other, their two ends are connected to the second bit code control terminal COM2 and the second segment code control terminal S2, respectively. After the LED D11 and the LED D15 are connected in reverse parallel to each other, their two ends are connected to the second bit code control terminal COM2 and the third segment code control terminal S3, respectively. After the LED D12 and the LED D16 are connected in reverse parallel to each other, their two ends are connected to the second bit code control terminal COM2 and the fourth segment code control terminal S4, respectively.

The third display unit 23 is composed of LEDs D17-D24. After the LED D17 and the LED D21 are connected in reverse parallel to each other, their two ends are connected to the third bit code control terminal COM3 and the first segment code control terminal S1, respectively. After the LED D18 and the LED D22 are connected in reverse parallel to each other, their two ends are connected to the third bit code control terminal COM3 and the second segment code control terminal S2, respectively. After the LED D19 and the LED D23 are connected in reverse parallel to each other, their two ends are connected to the third bit code control terminal COM3 and the third segment code control terminal S3, respectively. After the LED D20 and the LED D24 are connected in reverse parallel to each other, their two ends are connected to the third bit code control terminal COM3 and the fourth segment code control terminal S4, respectively.

The fourth display unit 24 is composed of LEDs D25-D32. After the LED D25 and the LED D29 are connected in reverse parallel to each other, their two ends are connected to the fourth bit code control terminal COM4 and the first segment code control terminal S1, respectively. After the LED D26 and the LED D30 are connected in reverse parallel to each other, their two ends are connected to the fourth bit code control terminal COM4 and the second segment code control terminal S2, respectively. After the LED D27 and the LED D31 are connected in reverse parallel to each other, their two ends are connected to the fourth bit code control terminal COM4 and the third segment code control terminal S3, respectively. After the LED D28 and the LED D32 are connected in reverse parallel to each other, their two ends are connected to the fourth bit code control terminal COM4 and the fourth segment code control terminal S4, respectively.

The fifth display unit 25 is composed of LEDs D33-D40. After the LED D33 and the LED D37 are connected in reverse parallel to each other, their two ends are connected to the fifth bit code control terminal COM5 and the first segment code control terminal S1, respectively. After the LED D34 and the LED D38 are connected in reverse parallel to each other, their two ends are connected to the fifth bit code control terminal COM5 and the second segment code control terminal S2, respectively. After the LED D35 and the LED D39 are connected in reverse parallel to each other, their two ends are connected to the fifth bit code control terminal COM5 and the third segment code control terminal S3, respectively. After the LED D36 and the LED D40 are connected in reverse parallel to each other, their two ends are connected to the fifth bit code control terminal COM5 and the fourth segment code control terminal S4, respectively.

The main control chip 11 can control the illumination of the LEDs of each display unit by controlling the high and low levels of each bit code control terminal and each segment code control terminal, so as to realize the number display of the electronic meter. For example, when the first bit code control terminal is at a high level and the other four bit code control terminals are all at a low level, the LEDs D5-D8 of the first display unit 21 are lit. If it is necessary to light the LEDs D1-D4 and the LEDs D5-D8 at the same time, the main control chip 11 is used for time-sharing lighting. The digital numbers of the electronic meter can be seen due to residual vision of the human eye.

To sum up, the feature of the present invention is that the LEDs used for display and the PCB used to control the display of the LEDs are directly welded together to form a whole, thereby realizing the stability of the connection of the display part of the electronic meter. After that, the PCB is connected to the support, and then the support and the panel are locked together, thereby realizing the relative separation of the display part of the electronic meter and the panel. Thus, the display effect of the electronic meter is improved. The display effect of the electronic meter won't be affected due to deformation of the panel 3 and loosening of screws, so as to improve the user experience.

In addition, in present invention, each display unit of the display module 12 of the electronic meter includes four LED units. The four LED units are connected to the four segment code control terminals, respectively. Each LED unit consists of two LEDs that are connected in reverse parallel to each other, so that the two LEDs share one segment code control terminal. Therefore, the number of the IO ports of the main control chip 111 occupied by the display unit is reduced, thereby reducing the cost of the display module.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A fitness equipment LED (light-emitting diode) electronic meter, comprising a PCB (printed circuit board), a support and a panel, the PCB being connected to a back surface of the support, the panel being locked to a front surface of the support;
a display module consisting of a plurality of LEDs (light-emitting diodes) being disposed on a front surface of the PCB, a plurality of first grooves passing through the support being disposed on the support, the LEDs being fitted in the first grooves;
a diffusion film and a semitransparent plate being sandwiched between the panel and the support, the diffusion film and the semitransparent plate sequentially abutting against the front surface of the support.

2. The fitness equipment LED electronic meter as claimed in claim 1, wherein the plurality of first grooves of the support are independent of each other.

3. The fitness equipment LED electronic meter as claimed in claim 1, wherein the PCB is in snap-fit with the back surface of the support.

4. The fitness equipment LED electronic meter as claimed in claim 1, wherein the support and the panel have corresponding locking holes.

5. The fitness equipment LED electronic meter as claimed in claim 4, wherein the locking hole of the support is in the form of an elongated hole.

6. The fitness equipment LED electronic meter as claimed in claim 1, wherein a second groove is disposed on the front surface of the support, and the diffusion film and the semitransparent plate are fitted in the second groove.

7. The fitness equipment LED electronic meter as claimed in claim 6, wherein a depth of the second groove is greater than a thickness of the diffusing film, but less than or equal to the sum of the thickness of the diffusing film and a thickness the semitransparent plate.

8. The fitness equipment LED electronic meter as claimed in claim 1, wherein the PCB further includes a main control chip, the display module has at least one bit code control terminal and four segment code control terminals, the bit code control terminal and the segment code control terminals are connected to IO ports of the main control chip, respectively;
the display module includes at least one display unit, the display unit is connected to the bit code control terminal; the display unit includes four LED units, each LED unit consists of two LEDs that are connected in reverse parallel to each other; one end of each of the four LED units is connected to the bit code control terminal connected to the display unit, another ends of the four LED units are connected to the four segment code control terminals, respectively.

9. The fitness equipment LED electronic meter as claimed in claim 8, wherein the PCB further includes a power supply module and a booster circuit module, and the power supply module is connected to the main control chip via the booster circuit module.

10. The fitness equipment LED electronic meter as claimed in claim 8, wherein the circuit further includes a voltage acquisition module, a sensor signal acquisition module, a heart rate signal acquisition module and a button circuit module, the voltage acquisition module is connected to the power supply unit and the main control chip, the sensor signal acquisition module, the heart rate signal acquisition module and the button circuit module are all connected to the main control chip.
